(19) United States
(12) Patent Application Publication
(10) Pub. No.: US 2015/0305951 A1
(43) Pub. Date: Oct. 29, 2015

(54) SIDE ARM EXTENSIONS AND MATTRESS ATTACHMENT COMPONENTS FOR PATIENT TRANSPORT DEVICES

(71) Applicant: FERNO-WASHINGTON, INC., Wilmington, OH (US)

(72) Inventors: Nicholas V. Valentino, Springboro, OH (US); Brian Magill, Morrow, OH (US); Timothy Dietz, Springboro, OH (US)

(73) Assignee: Ferno-Washington, Inc., Wilmington, OH (US)

(21) Appl. No.: 14/649,260

(22) PCT Filed: Dec. 4, 2013
(86) PCT No.: PCT/US13/73005

§ 371 Date: Jun. 3, 2015

Related U.S. Application Data
(60) Provisional application No. 61/733,072, filed on Dec. 4, 2012.

(51) Int. Cl. A61G 1/04; A61G 7/075

(52) U.S. Cl. CPC A61G 1/04; A61G 7/075

(57) ABSTRACT

Embodiments of a side arm extension for a patient transport device comprise a patient transport device engagement member configured to engage a patient transport device frame or a support frame attached to the patient transport device frame, the side arm extension further comprising a rotatable and pivotable arm rest, and a side arm motion base connecting the arm rest to the patient transport device engagement member. The side arm motion base comprises, a rotational mechanism configured to rotate the arm rest, and a swing mechanism configured to pivot outwardly from the arm rest perpendicular to a perimeter of the patient transport device frame or patient transport device support frame.

### CROSS-REFERENCE TO RELATED APPLICATIONS

This application claims priority to U.S. provisional application 61/733,072 filed Dec. 4, 2012, which is incorporated by reference herein in its entirety.

### SUMMARY

The present invention is generally related to emergency cots, and is specifically directed to side arm extensions for patient transport devices, such as ambulance cots, stretchers, stair chairs, and the like. Additionally, the present invention is generally directed to mattress attachment members, specifically, mattress attachment members for ambulance cots.

According to one embodiment, a side arm extension for a patient transport device is provided. The side arm extension comprises a patient transport device engagement member configured to engage a patient transport device frame or a support frame attached to the patient transport device frame, the side arm extension further comprising a rotatable and pivotable arm rest, and side arm motion base connecting the arm rest to the patient transport device engagement member. The side arm motion base comprises, a rotational mechanism configured to rotate the arm rest; and a swing mechanism configured to pivot outwardly from the arm rest perpendicular to a perimeter of the patient transport device frame or patient transport device support frame.

According to another embodiment, an ambulance cot mattress is provided. comprising a mattress having a patient support side, a cot frame coupling side opposite the patient support side, and a plurality of mattress coupling members attached to the a cot frame coupling side and configured to attach the mattress to the support frame. Each mattress coupling member comprises a rotatable insert operable to be inserted into a slot of the support frame, wherein rotation of the mattress coupling member secures the mattress coupling member to the slot of the support frame.

### BRIEF DESCRIPTION OF THE DRAWINGS

The following detailed description of specific embodiments of the present invention can be best understood when read in conjunction with the following drawings, where like structure is indicated with like reference numerals and in which:

FIG. 1 is a perspective view of an ambulance cot having a side arm extension positioned substantially parallel to the lower torso section of the cot as the back rest is in an upright position according to one or more embodiments of the present invention;

FIG. 2 is a perspective view of an ambulance cot having a side arm extension positioned substantially parallel to the lower torso section of the cot as the back rest is lowered according to one or more embodiments of the present invention;

FIG. 3 is a perspective view of an ambulance cot having a side arm extension positioned substantially parallel to the lower torso section of the cot as the back rest is lowered, but rotated 180° relative to the position of FIG. 2, according to one or more embodiments of the present invention;

FIG. 4 is a top view of an ambulance cot having the side arm extension shown in FIG. 3, according to one or more embodiments of the present invention;

FIG. 5 is a perspective view of an ambulance cot having a side arm extension pivoted outwardly according to one or more embodiments of the present invention;

FIG. 6 is a perspective side view of a side arm extension according to one or more embodiments of the present invention;

FIG. 7 is another perspective view of a side arm extension according to one or more embodiments of the present invention;

FIG. 8 depicts the internal ratchet mechanism of the arm rest of the side arm extension according to one or more embodiments of the present invention;

FIG. 9 is a rotated view of the internal ratchet mechanism shown in FIG. 9 according to one or more embodiments of the present invention;

FIG. 10 is another view of the side arm extension with components shown in phantom to highlight swing/pivot features according to one or more embodiments of the present invention;

FIG. 11 is a top view of side arm extension in outwardly pivoted position according to one or more embodiments of the present invention;

FIG. 12 depicts an internal paddle latching mechanism of the arm rest of the side arm extension in a non-pivot configuration according to one or more embodiments of the present invention;

FIG. 13 depicts the internal paddle latching mechanism when the side arm extension is outwardly pivoted according to one or more embodiments of the present invention;

FIG. 14 depicts a cross-sectional view of the side arm extension according to one or more embodiments of the present invention;

FIG. 15 is a side view of a mattress for an ambulance cot having mattress attachment members according to one or more embodiments of the present invention;

FIG. 16 is a bottom view of a mattress for an ambulance cot having mattress attachment members according to one or more embodiments of the present invention;

FIG. 17 is an exploded view depicting the coupling of the mattress to the backrest of an ambulance cot via the mattress attachment members according to one or more embodiments of the present invention;

FIG. 18 is a bottom view depicting the coupling of the mattress to the backrest of an ambulance cot via the mattress attachment members according to one or more embodiments of the present invention;

FIG. 19 depicts the cot attachment side of the mattress attachment member in nonlocking positions, wherein the mattress according to one or more embodiments of the present invention;

FIG. 20 depicts the mattress attachment side of the mattress attachment member according to one or more embodiments of the present invention;

FIG. 21 depicts the cot attachment side of the mattress attachment member in the locking position according to one or more embodiments of the present invention; and

FIG. 22 depicts another mattress attachment member according to one or more embodiments of the present invention; and

The embodiments set forth in the drawings are illustrative in nature and not intended to be limiting of the invention defined by the claims. Moreover, individual features of the drawings and invention will be more fully apparent and understood in view of the detailed description.

### DETAILED DESCRIPTION

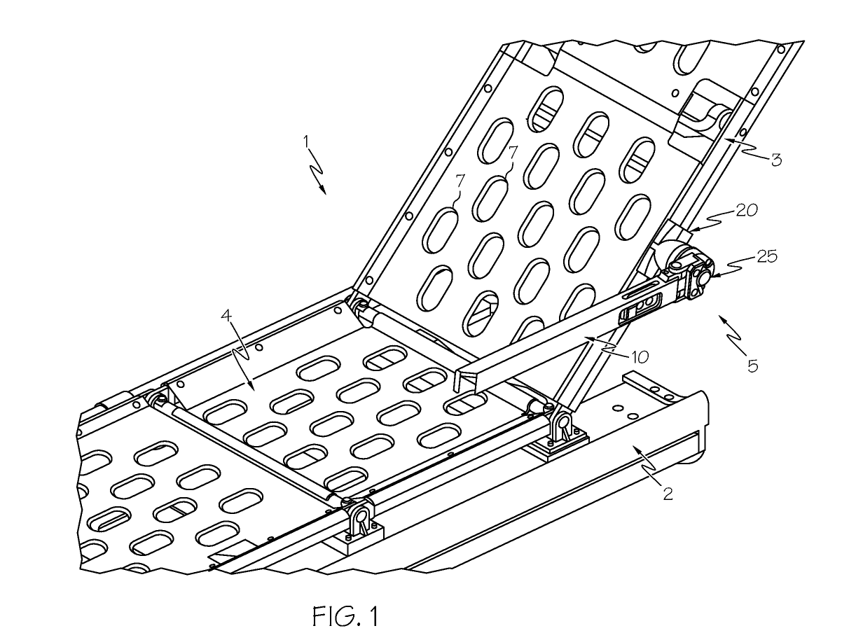

Referring to FIG. 1, an ambulance cot 1 comprising side arm extensions 5 is provided. While the figures depict attachment to an ambulance cot 1, it is contemplated that any patient transport device, e.g., cot, wheel chair, stretcher, stair chair, or the like may utilize the side arm extension. The side arm extensions 5 comprise a patient transport device engagement member 20 utilized for engaging a frame 2 of a patient transport device (e.g., an ambulance cot 1) along the perimeter of the patient transport device frame (e.g., cot frame 2) or a support frame 3 attached to the cot frame. The support frame 3 is a support platform with outer rails that support a patient. The side arm extensions 5 are typically attached to rails to the support frame 3; however, it is contemplated that it could also be attached to the cot frame 2. The side arm extensions 5 also include a rotatable and pivotable arm rest 10, and a side arm motion base 25 connecting the arm rest 10 to the patient transport device engagement member 20.

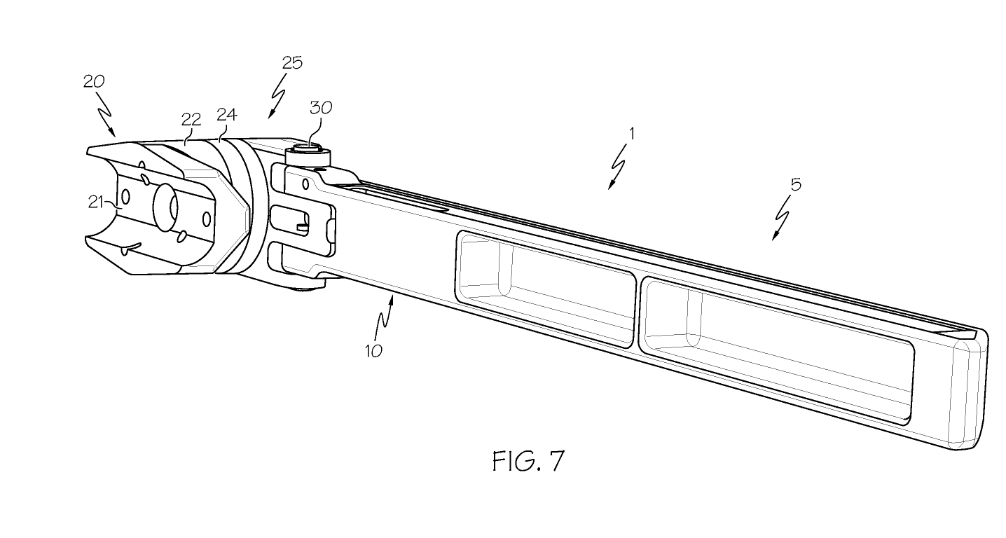

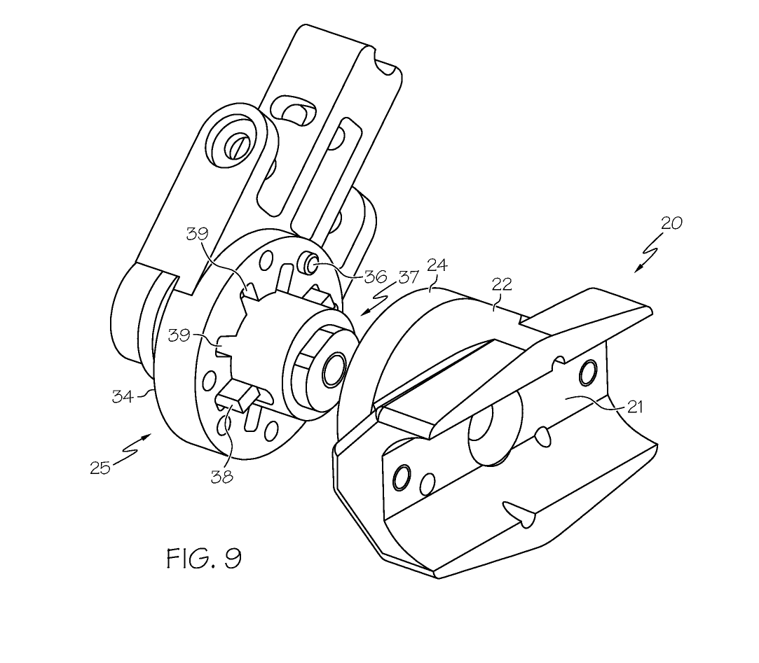

As shown in the embodiment of FIG. 9, the patient transport device coupling member 20 may comprise a stationary section 22, which is coupled to the support frame 3 via a contoured surface 21, and also comprises a rotatable section 24, which attaches to and is rotatable with the side arm motion base 25. Referring to the embodiment FIG. 7, the patient transport device engagement member 20 may include a contoured surface 21 suitable for a snap attachment onto a side bar on the support frame 3 perimeter. Various coupling mechanisms are contemplated for use as the patient transport device engagement member, for example, the snap fit mentioned above. Additional fasteners (not shown) may be utilized to ensure the side extension is firmly secured to the side bar or side rail. Referring to FIG. 1, the patient transport device engagement member 20 is typically coupled to one or more side rails adjacent the back rest of the support frame 3; however, other positions are contemplated herein.

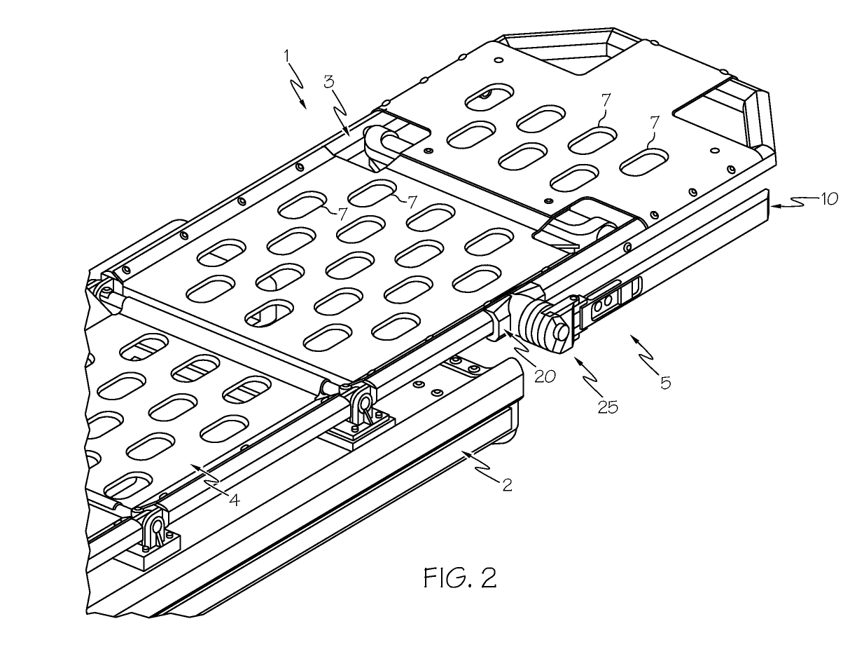

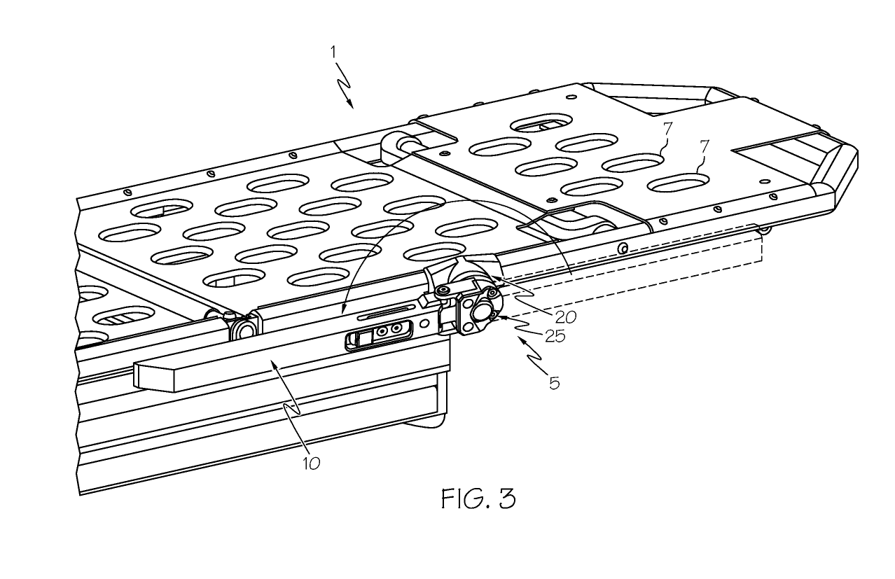

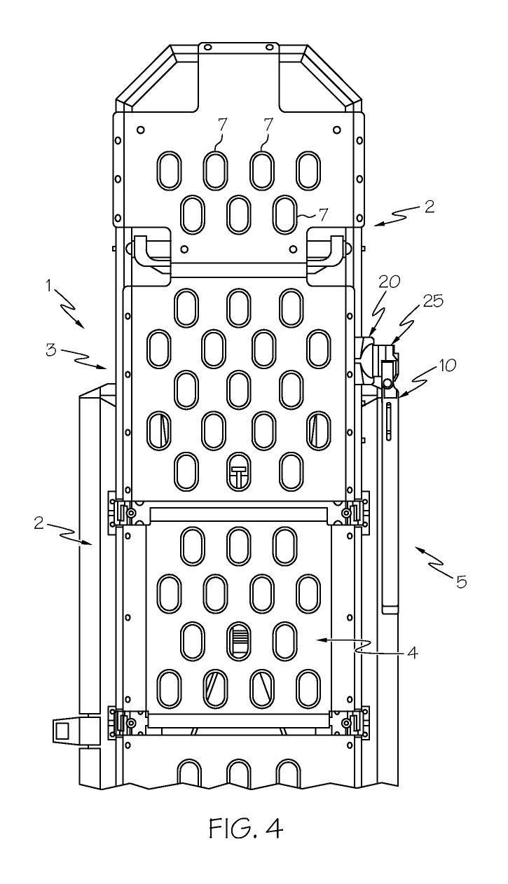

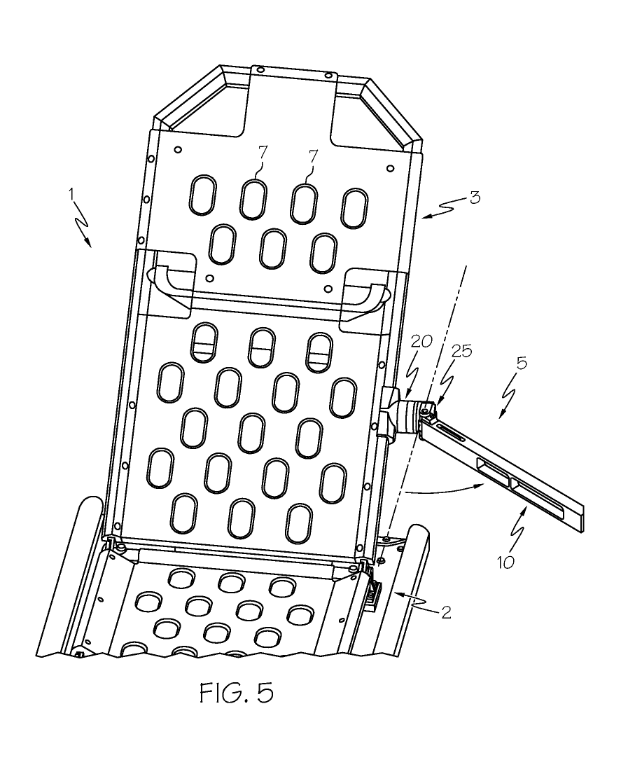

As will be detailed below, the side arm extension 5 comprises components which allow the side arm extension 5 to rotate, and pivot outwardly perpendicular to the perimeter of the support frame 3. In one configuration shown in FIG. 1, when the back rest is raised to an upright position, and the arm rest 10 may be rotated such that the lower torso section 4 of the cot 1 is horizontally parallel to the arm rest 10. Alternatively, when in a non-upright position as depicted in FIGS. 2-4 (i.e., in exemplary positions wherein the side arm extension are generally not in use), the side arm extension 5 may be rotated such that the end of the arm rest 10 is positioned near the head section of the support frame 3 (See FIG. 2) or rotated such that the end of the arm rest 10 is positioned near the lower torso section 4 of the support frame 3 (See FIGS. 3 and 4). Furthermore, as shown in FIG. 5, the arm rest 10 may pivot or swing outwardly as shown. This outward pivoting motion may be beneficial to large or obese patients, who may not easily fit in the spacing between the arm rests 10 when in a non-pivoted position.

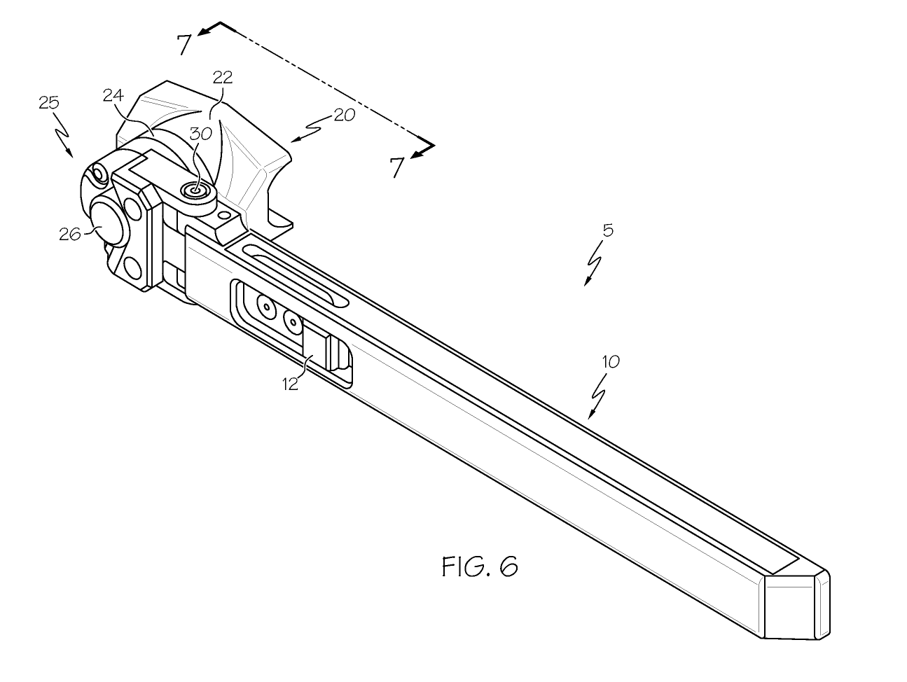

Referring to FIGS. 6 and 9, the side arm motion base 25 includes a rotational mechanism (e.g., ratchet mechanism 37) configured to rotate the arm rest 10, and a swing mechanism configured to pivot the arm rest outwardly away from the perimeter of the cot frame perimeter. The rotational mechanism allows for up to 360° of rotational freedom, or in a specific embodiment, the rotational mechanism allows for up to 180° of rotational freedom.

The swing mechanism allows for up to 90° of pivotal movement, or in a specific embodiment, up to 25° of rotation relative to the side arm motion base.

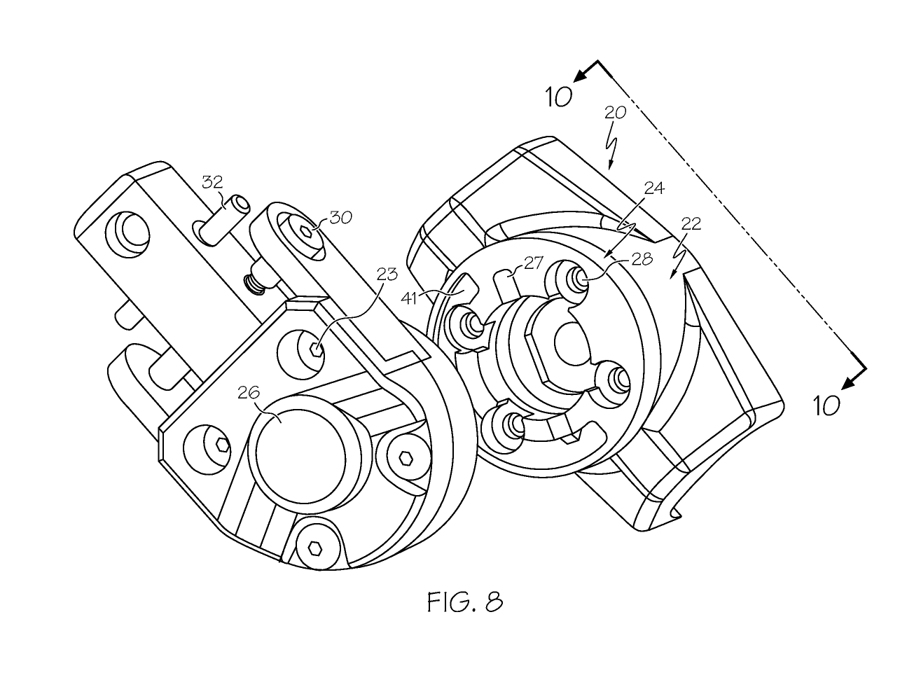

In one embodiment, the rotational mechanism is a ratchet device as depicted in FIGS. 8 and 9. Referring to FIGS. 8 and 9, the ratchet mechanism 37 of the side arm motion base 25 comprises at least one tab 38 which is inserted into a slot 27 of the patient transport device coupling member 20 to facilitate coupling of the patient transport device coupling member 20 to the side arm motion base 25. While only one tab is shown it is contemplated to include another tab. Optionally, a tab perpendicular to the other tab 38 may be incorporated such that the two blades form a stacking arrangement to increase the load which can be handled. Furthermore, the coupling of the patient transport device coupling member 20 to the side arm motion base 25 may also include an additional fastener. For example and not by way of limitation, the side arm motion base 25 may include a threaded bolt 23 which engages the corresponding threaded hole 28 of the patient transport device coupling member.

Additionally, to facilitate rotation of the arm rest 10, the ratchet mechanism 37 is provided with discrete positional slots 39. When the tab 38 is disengaged from the slot 27 of the patient transport device coupling member 20 by a suitable actuation mechanism (e.g., button 26), the tab 38 may move between discrete positional slots 39, which thereby facilitates rotation of the arm rest 10 to different positions. As shown in FIG. 9, the positional slots 39 define the possible rotational positions for the side arm extension 5. In one embodiment as shown in FIGS. 8 and 9, the side arm motion base 25 may also comprise a locking pin 36 to limit rotation of the arm rest 10. Specifically, the locking pin 36 of the side arm motion base 25 moves within curved slot 41. In operation, the slot 41 defines the maximum rotation of the locking pin 36, which thereby defines the maximum rotation of the side arm motion base 25 and arm rest 10 attached thereto.

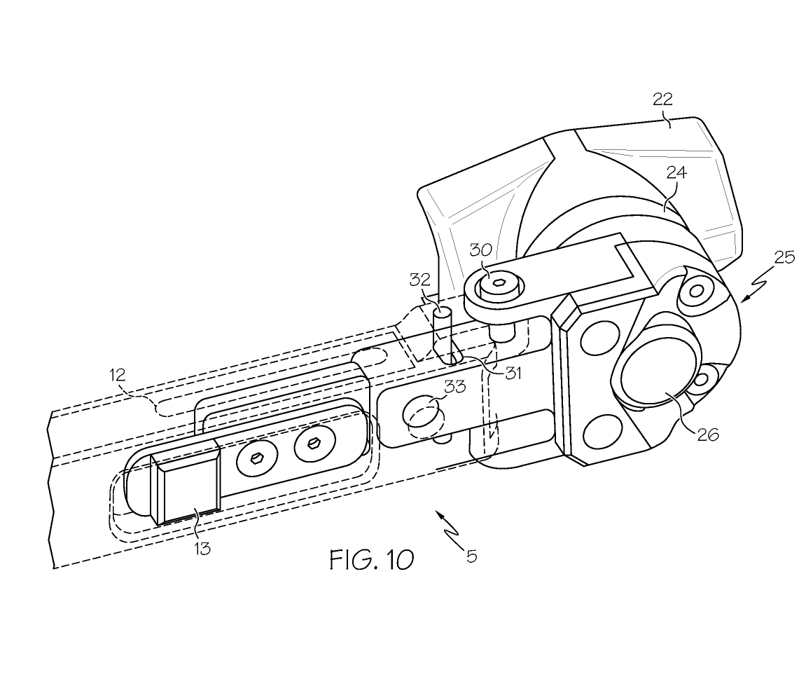

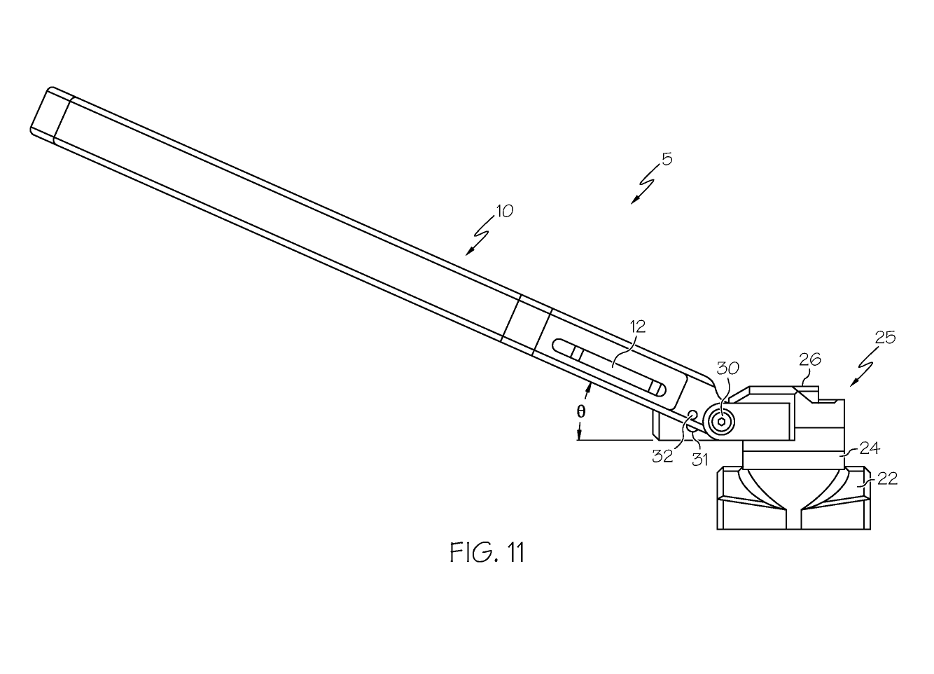

Turning to the swing mechanism as shown in FIG. 10, the side arm motion base 25 comprises a stationary rod 30 which is inserted to slots of the arm rest 10. Referring to FIGS. 5 and 11, the arm rest 10 is configured to pivot about stationary rod 30 to the swinging motion of the arm rest 10. As shown in the embodiment of FIG. 10, the swing mechanism comprises an internal spring 33 which maintains the arm rest 10 in an outwardly pivoted (See FIG. 11) or unpivoted position (See FIG. 10).

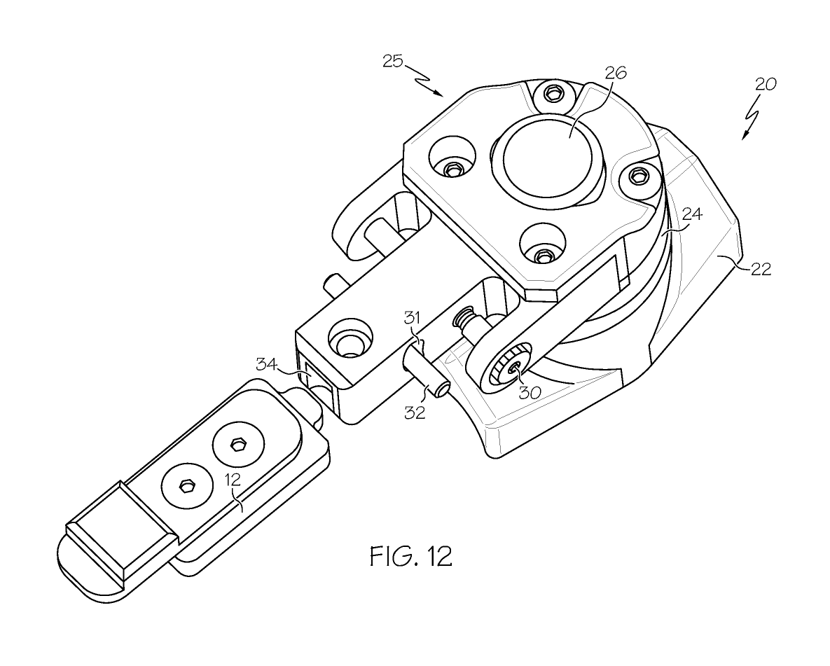

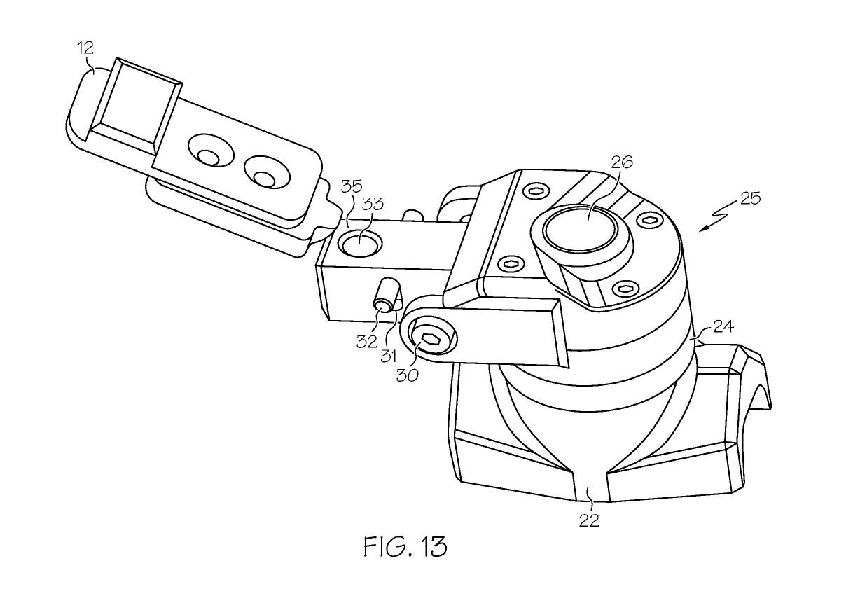

Referring to FIG. 12, the spring may be disengaged by a suitable actuation mechanism, for example, a paddle latch 12, which is also configured to slidingly engage a lower lip 34 of the side arm motion base 25 and thereby prevent pivoting of the arm rest 10. As shown in FIG. 10, pulling the slide lever 13 of the paddle latch 12 allows the paddle latch 12 to be slidingly disengaged to allow for pivoting of the arm rest 10. Referring to FIG. 13, after pivoting, the paddle latch 12 may engage an upper lip 35 of the side arm motion base 25 thereby securing the position of the arm rest 10 in an outwardly pivoted position.

In further embodiments, it may be desirable to reduce the radius of swinging, for example, to about 90°, or in a specific embodiment, to about 25°. Referring to FIG. 11, the arm rest 10 includes a pin 32, which is able to move within elongated slot 31 of the side arm motion base 25. The movement of the arm rest 10 is limited to the degree of movement of the pin 32 within elongated slot 31.

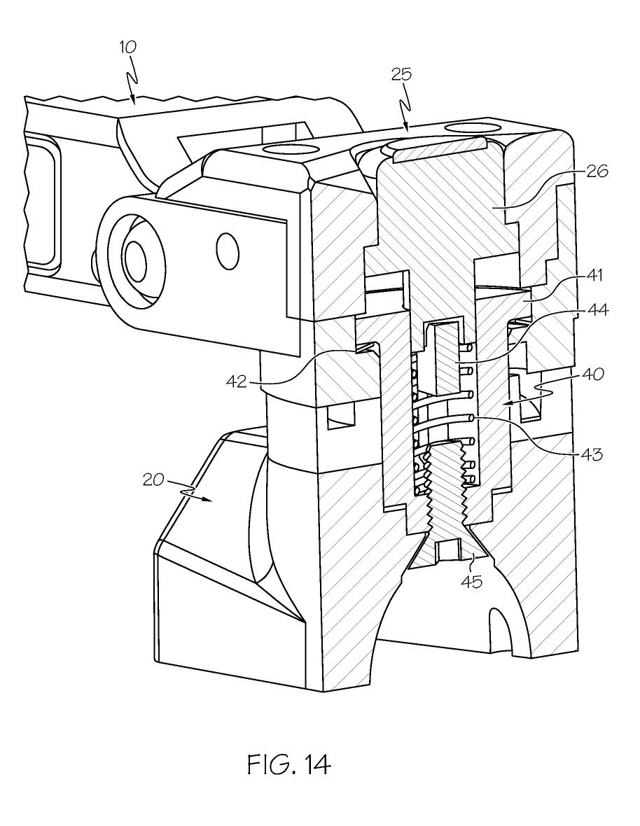

Additionally, FIG. 14 depicts a cross-sectional view of the side arm extension 5, specifically depicting internal components that increase the durability of the side arm extensions 5. For example, the attachment of the patient transport device coupling member 20 to the side arm motion base 25 utilizes a bushing 40 with an upper flange member 41 annularly surrounding a biasing member, e.g., spring 43. The bushing 40 has a lower threaded portion to engage a screw member 45, which helps secure the patient transport device coupling member 20 to the side arm motion base 25. When the button 26 is compressed to release the arm rest 10, the button 26 may contact beam 44 which compresses spring member 43.

Further as shown in FIG. 14, although the bottom screw 45 keeps the side arm motion base 25 securely stacked on the patient transport device coupling member 20, a gap may emerge in the stack, for example, a gap underneath the upper flange member 41, thereby creating a rattling effect. To counteract the potential rattling effect, a wave washer 42 may be included underneath the flange 41 to ensure the assembly is tight.

While the above embodiments are directed to a side arm for an ambulance cot, it is further contemplated that the side arm extension could be coupled to other patient transport devices such as stair chairs, wheel chairs, stretchers, etc.

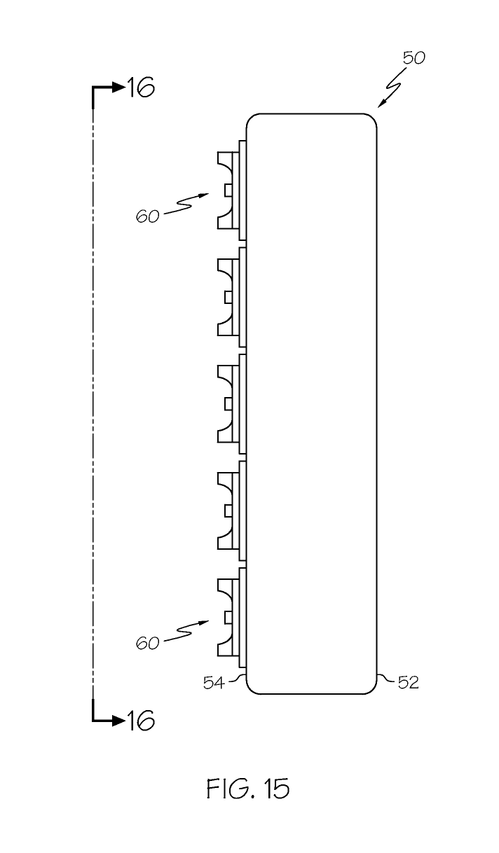

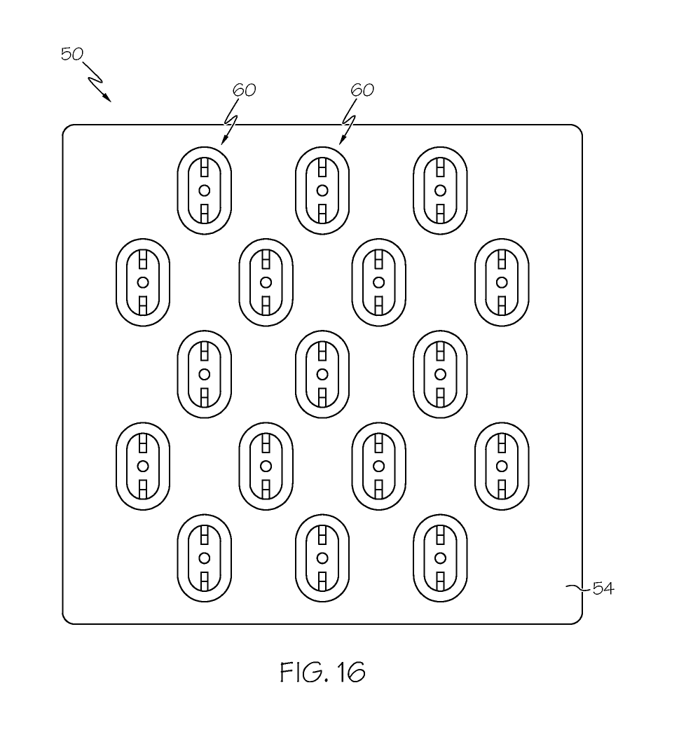

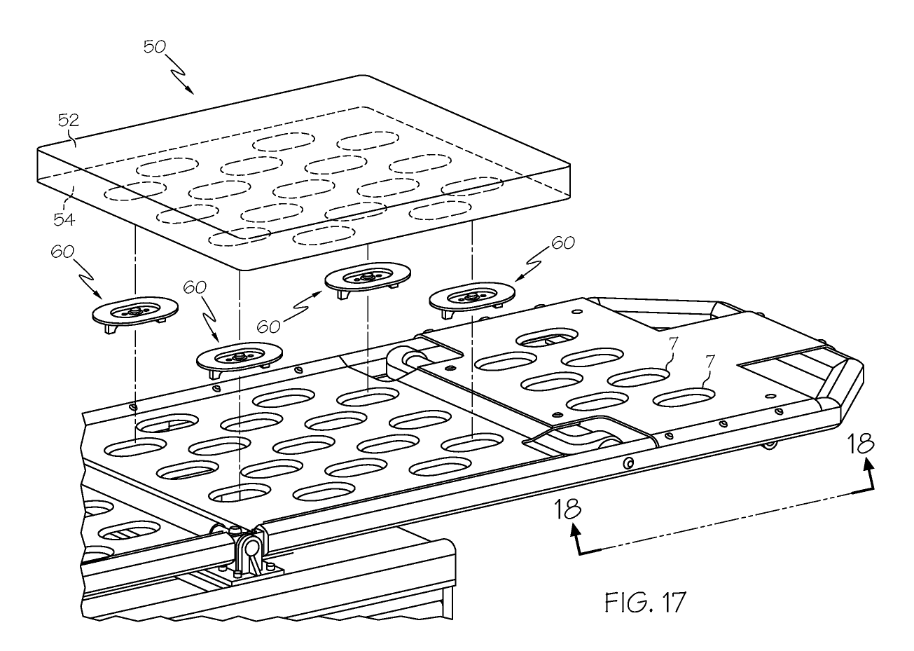

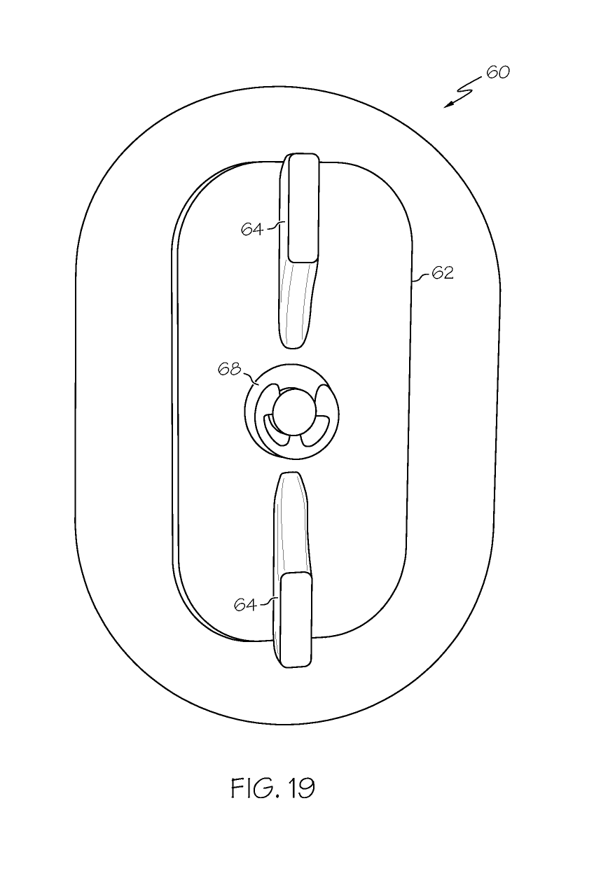

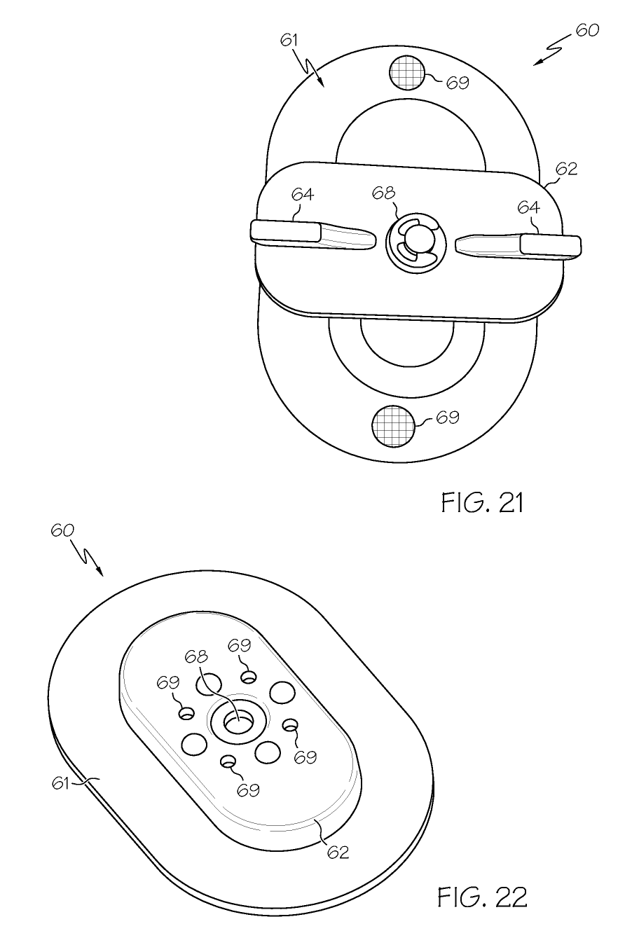

The present disclosure is also directed to an ambulance cot mattress fastening component. Referring to FIGS. 15 and 17, the mattress 50 comprises a patient support side 52, a cot frame coupling side 54 opposite the patient support side 52, and a mattress coupling member 60 attached to the a cot frame coupling side 54 and configured to attach the mattress 50 to the support frame 3. Referring to FIGS. 17-21, the mattress coupling member 60 defines an outer ring 61, and a rotatable insert 62 concentrically disposed within the ring. The rotatable insert 62 is operable to be inserted into a slot 7 of the support frame 3.

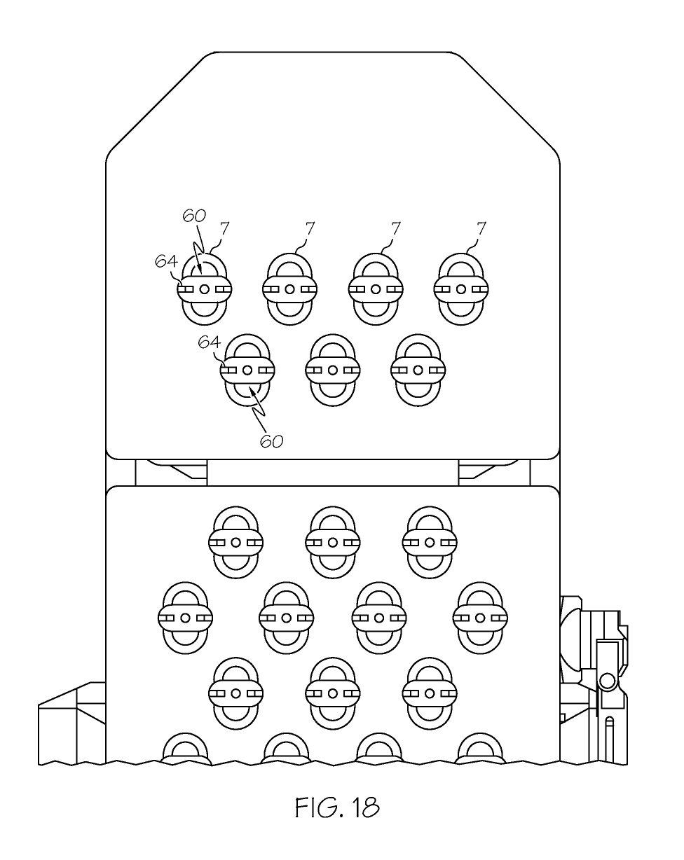

Referring to FIGS. 18-19 and 21, after the rotatable insert 62 is provided in slot 7, the mattress coupling member 60 may be secured in the slot 7 by rotating flange member 64 about central pin 68. In this manner, the outer ring 61, which has a larger diameter than slot 7, will engage the top surface of the support frame 3, while the rotatable insert 62, upon rotation, engages the underneath surface of the support frame 3 (See FIG. 18). As shown, these mattress coupling members 60 are easy to secure and easy detach from the slots 7 of the support frame 3. Thus, the process of removing or changing cot mattresses 50 is simplified.

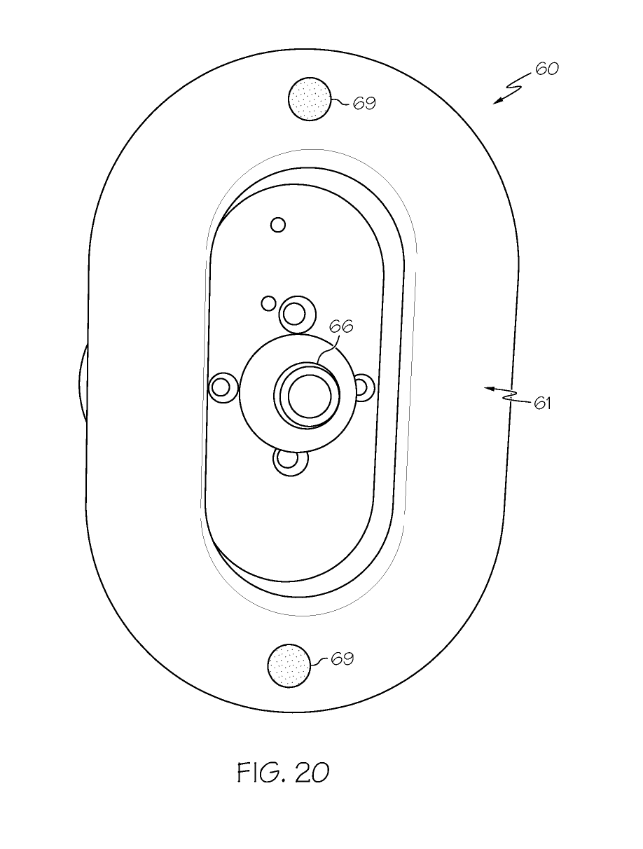

In a further embodiment as shown in FIGS. 20-22, the mattress coupling members 60 may include vents 69, which are used to release any build up of air to prevent a “ballooning” effect in the mattress 50. As shown, the vents 69 are typically located on the outer ring 61; however, it is contemplated to include the vents 69 at other locations on the mattress coupling member 60 or the mattress 50. In another embodiment, the mattress coupling members 60 may include vents 69 disposed on the rotatable insert 62.

It is further noted that terms like “preferably,” “generally”, “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A side arm extension for a patient transport device comprising a patient transport device engagement member configured to engage a patient transport device frame or a support frame attached to the patient transport device frame, the side arm extension further comprising a rotatable and pivotable arm rest, and side arm motion base connecting the arm rest to the patient transport device engagement member, wherein the side arm motion base comprises,
a rotational mechanism configured to rotate the arm rest; and
a swing mechanism configured to pivot outwardly from the arm rest perpendicular to a perimeter of the patient transport device frame or patient transport device support frame.

2. The side arm extension of claim 1 wherein the patient transport device is an ambulance cot, a stretcher, a wheel chair, or a stair chair.

3. The side arm extension of claim 1 wherein the patient transport device is an ambulance cot.

4. The side arm extension of claim 1 wherein the rotational mechanism is a ratchet device.

5. The side arm extension of claim 1 wherein the rotational mechanism allows for up to 360° of rotational freedom.

6. The side arm extension of claim 1 wherein the rotational mechanism allows for up to 180° of rotational freedom.

7. The side arm extension of claim 6 wherein the ratchet mechanism comprises a locking pin configured to limit rotation of the arm rest.

8. The side arm extension of claim 7 wherein the ratchet mechanism comprises a button to disengage the locking pin.

9. The side arm extension of claim 1 wherein the side arm motion base comprises a stationary rod which the arm rest pivots about during swinging motion.

10. The side arm extension of claim 1 wherein the swing mechanism comprises an internal spring which maintains the arm rest in outwardly pivoted or unpivoted position.

11. The side arm extension of claim 1 wherein the swing mechanism allows for up to 90° of pivotal movement.

12. The side arm extension of claim 1 wherein the swing mechanism allows for up to 25° of of pivotal movement.

13. The side arm extension of claim 1 wherein the arm rest comprises a paddle latch configured to slidingly engage a lower lip of the side arm motion base and thereby prevent pivoting of the arm rest, and is configured to be slidingly disengaged to allow for pivoting of the arm rest.

14. The side arm extension of claim 13 wherein the paddle latch is configured to slidingly engage an upper lip of the side arm motion base after outward pivoting of the arm rest, thereby securing the arm rest in place.

15. The side arm extension of claim 1 wherein the cot engagement member is contoured to be snapped on a side bar on a perimeter of the patient transport device frame.

16. An ambulance cot mattress comprising a mattress having a patient support side, a cot frame coupling side opposite the patient support side, and a plurality of mattress coupling members attached to the a cot frame coupling side and configured to attach the mattress to the support frame, wherein each mattress coupling member comprises
a rotatable insert operable to be inserted into a slot of the support frame, wherein rotation of the mattress coupling member secures the mattress coupling member to the slot of the support frame.

17. The ambulance cot mattress of claim 16 wherein the rotatable insert is concentrically disposed within an outer ring of the mattress coupling member.

18. The ambulance cot mattress of claim 16 wherein the rotatable insert comprises a rotating flange member.

19. The ambulance cot mattress of claim 16 wherein the mattress coupling members comprise one or more vents.
